(19) United States
(12) Patent Application Publication
(10) Pub. No.: US 2024/0154921 A1
(43) Pub. Date: May 9, 2024

(54) QA DATA EVALUATION APPARATUS

(71) Applicant: NEC Corporation, Minato-ku, Tokyo (JP)

(72) Inventor: Daichi CHONO, Tokyo (JP)

(73) Assignee: NEC Corporation, Minato-ku, Tokyo (JP)

(21) Appl. No.: 18/282,113

(22) PCT Filed: Mar. 23, 2021
(86) PCT No.: PCT/JP2021/011973

§ 371 Date: Sep. 14, 2023

(51) Int. Cl. H04L 51/02; H04L 51/216

(52) U.S. Cl. CPC H04L 51/02; H04L 51/216

(57) ABSTRACT

A QA data evaluation apparatus includes: an acquiring unit that acquires QA data including a content of a question from a user to a chatbot and a content of a response to the question by the chatbot, and log information on use of the chatbot by the user; an extracting unit that extracts a feature value relating to a temporal behavior of the use of the chatbot by the user from the log information; and a generating unit that generates QA data evaluation information representing whether the QA data is good or bad based on the feature value.

### TECHNICAL FIELD

The present invention relates to a QA data evaluation apparatus, a QA data evaluation method, and a recording medium.

### BACKGROUND ART

An information processing system that presents an appropriate response text to a chat user in response to a question text transmitted from the chat user has been proposed or put into practical use as a chatbot system. A chatbot system refers to a QA data DB (database) that stores QA data including an expected question text and a response text for the question text associated with each other, and thereby acquires a response text corresponding to a question text transmitted from a chat user and presents the response text to the chat user. Therefore, it is no exaggeration to say that the reliability of a chatbot system is determined by the quality of QA data. Thus, the administrator of a chatbot system creates learning data representing whether QA data is good or bad based on the result of actual operation in order to increase the quality of the QA data, and conducts maintenance such as modification, deletion and supplement of the QA data based on the learning data. Whether QA data is good or bad can be evaluated by a chat user inputting evaluation information indicating whether or not a response included by the QA data is appropriate for a question. Evaluation information that is actively input by a chat user in the above manner will be referred to as “active evaluation information” hereinafter. On the other hand, evaluation information that is not actively input by a chat user will be referred to as “inactive evaluation information” hereinafter.

For example, Patent Literature 1 discloses acquiring the inflection and pitch of chat user's voice after presenting a response as inactive evaluation information and creating learning data representing whether QA data is good or bad based on the acquired information.

Further, Patent Literature 2 discloses acquiring, as inactive evaluation information, text information obtained by converting an utterance issued by a chat user to a chatbot's response into text, audio data obtained by digitalizing the sound of the utterance, image data obtained by digitalizing an image showing the appearance of the chat user when the chat user heard the response, and biometric information (pulse, heart rate, blood pressure, brain waves, respiration rate, etc.) of the chat user before and after a moment that the chat user heard the response.

Further, as a technique relating to a chatbot, Patent Literature 3 discloses a technique of searching for a chatbot service that can be used with reliability among many chatbot services based on the number of users per unit time, the average usage time of the users, and chat content information.

### CITATION LIST

### Patent Literature

Patent Literature 1: Japanese Unexamined Patent Application Publication No. JP-A 2020-091513
Patent Literature 2: Japanese Unexamined Patent Application Publication No. JP-A 2019-045978
Patent Literature 3: Japanese Unexamined Patent Application Publication No. JP-A 2019-185614
Patent Literature 4: Japanese Patent Publication No. 5817531

### SUMMARY OF INVENTION

### Technical Problem

However, there is a case where it is difficult to acquire inactive evaluation information from a chat user.

A major object of the present invention is to provide an information processing apparatus that makes it possible to easily acquire inactive evaluation information.

### Solution to Problem

A QA data evaluation apparatus as an aspect of the present invention includes:
an acquiring unit that acquires QA data including a content of a question from a user to a chatbot and a content of a response to the question by the chatbot, and log information on use of the chatbot by the user;
an extracting unit that extracts a feature value relating to a temporal behavior of the use of the chatbot by the user from the log information; and
a generating unit that generates QA data evaluation information representing whether the QA data is good or bad based on the feature value.

Further, a QA data evaluation method as an aspect of the present invention includes:
acquiring QA data including a content of a question from a user to a chatbot and a content of a response to the question by the chatbot, and log information on use of the chatbot by the user;
extracting a feature value relating to a temporal behavior of the use of the chatbot by the user from the log information; and
generating QA data evaluation information representing whether the QA data is good or bad based on the feature value.

Further, a computer-readable recording medium as an aspect of the present invention has a program recorded thereon, and the program includes instructions for causing a computer to execute:
a process to acquire QA data including a content of a question from a user to a chatbot and a content of a response to the question by the chatbot, and log information on use of the chatbot by the user;
a process to extract a feature value relating to a temporal behavior of the use of the chatbot by the user from the log information; and
a process to generate QA data evaluation information representing whether the QA data is good or bad based on the feature value.

### Advantageous Effects of Invention

With the configurations as described above, the present invention makes it possible to easily acquire inactive evaluation information.

### BRIEF DESCRIPTION OF DRAWINGS

FIG. 1 is a block diagram of an information processing apparatus according to a first example embodiment of the present invention.

FIG. 2 is a view showing an example of a configuration of a QA data DB in the information processing apparatus according to the first example embodiment of the present invention.

FIG. 3 is a view showing an example of a configuration of a chat log DB in the information processing apparatus according to the first example embodiment of the present invention.

FIG. 4 is a view showing an example of a configuration of a cluster DB in the information processing apparatus according to the first example embodiment of the present invention.

FIG. 5A is a view showing an example of a configuration of a rule DB in the information processing apparatus according to the first example embodiment of the present invention.

FIG. 5B is a view showing an example of a rule in the information processing apparatus according to the first example embodiment of the present invention.

FIG. 5C is a view showing another example of the rule in the information processing apparatus according to the first example embodiment of the present invention.

FIG. 6 is a view showing an example of a configuration of a learning data DB in the information processing apparatus according to the first example embodiment of the present invention.

FIG. 7 is a flowchart showing an example of a chatbot process and a chat log collection process in the information processing apparatus according to the first example embodiment of the present invention.

FIG. 8 is a flowchart showing an example of a learning data generation process in the information processing apparatus according to the first example embodiment of the present invention.

FIG. 9 is a view showing an example of chat log information in the information processing apparatus according to the first example embodiment of the present invention.

FIG. 10 is a view showing an example of a document generated by collecting question texts and response texts in the log information in the information processing apparatus according to the first example embodiment of the present invention.

FIG. 11 is a flowchart showing an example of processing executed at step S25 by a learning data generating unit in the information processing apparatus according to the first example embodiment of the present invention.

FIG. 12 is a view showing an example of a chatbot management screen in the information processing apparatus according to the first example embodiment of the present invention.

FIG. 13 is a block diagram of a QA data evaluation apparatus according to a second example embodiment of the present invention.

### DESCRIPTION OF EMBODIMENTS

Next, example embodiments of the present invention will be described in detail with reference to the drawings.

### First Example Embodiment

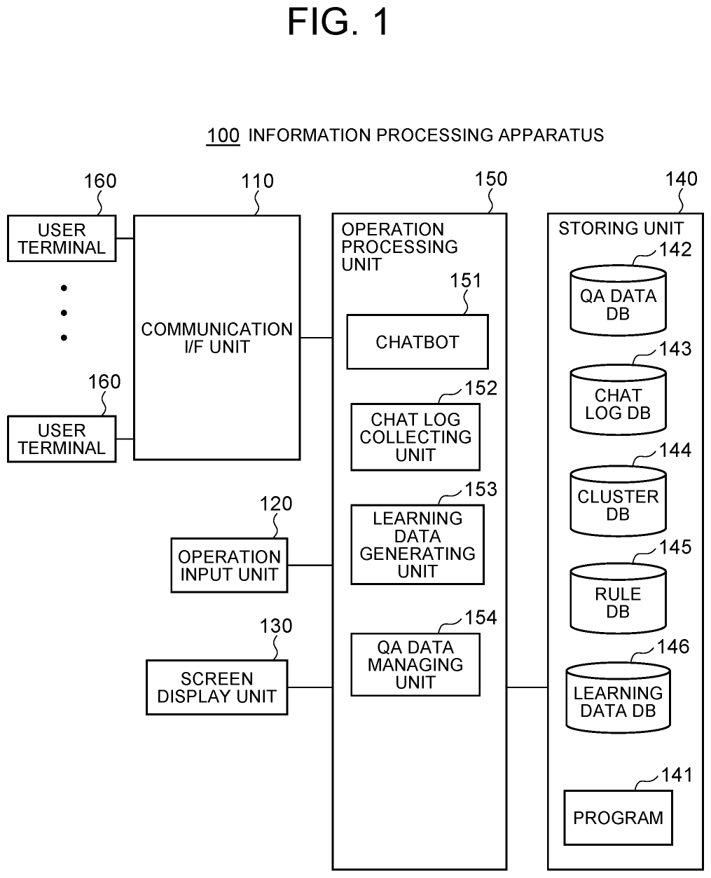

FIG. 1 is a block diagram of an information processing apparatus 100 according to a first example embodiment of the present invention. Referring to FIG. 1, the information processing apparatus 100 has a function of a chatbot to output an appropriate response text to a terminal device operated by a chat user in response to a question text received from the terminal device operated by the chat user, and a function to evaluate QA data used by the chatbot. The information processing apparatus 100 includes, as main components, a communication I/F (interface) unit 110, an operation input unit 120, a screen display unit 130, a storing unit 140, and an operation processing unit 150.

The communication I/F unit 110 is composed of a data communication circuit, and is configured to perform data communication with one or more user terminals 160 wirelessly or by wire. The user terminal 160 is an information processing apparatus used by a user (chat user) who has a chat with the chatbot. The user terminal 160 is, for example, a personal computer, a smartphone, a tablet terminal and the like having a communication function. Any external device, which is not shown, other than the user terminal 160 may be connected to the communication OF unit 110. The operation input unit 120 is composed of devices such as a keyboard and a mouse, and is configured to detect an operator's operation and output to the operation processing unit 150. The screen display unit 130 is composed of a device such as an LCD (Liquid Crystal Display), and is configured to display various types of information on a screen in response to instructions from the operation processing unit 150.

The storing unit 140 is composed of one or more storage devices such as a hard disk and a memory, and is configured to store processing information and a program 141 that are required for a variety of processing in the operation processing unit 150. The program 141 is a program that is loaded to and executed by the operation processing unit 150 to implement various processing units, and is previously loaded from an external device or a recording medium, which is not shown, via a data input/output function such as the communication I/F unit 110 and stored in the storing unit 140. Main processing information stored in the storing unit 140 includes a QA data DB 142, a chat log DB 143, a cluster DB 144, a rule DB 145, and a learning data DB 146.

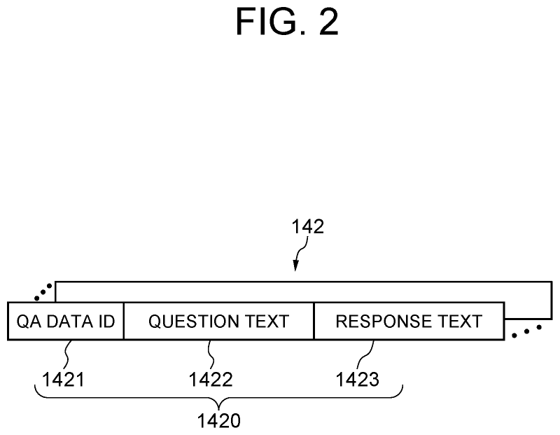

The QA data DB 142 is a database that stores QA data including a question text and a response text associated with each other. FIG. 2 shows an example of a configuration of the QA data DB 142. The QA data DB 142 in this example is composed of a plurality of entries, each storing one QA data 1420. The QA data 1420 stored in each entry includes a QA data ID 1421, a question text 1422, and a response text 1423. In the field of the QA Data ID 1421, an ID such as a number for uniquely identifying the QA Data 1420 is set. In the field of the question text 1422, text information on a question expected to be asked by a chat user is set. In the field of the response data 1424, text information on a response associated with an inquiry by the question text 1422 is set.

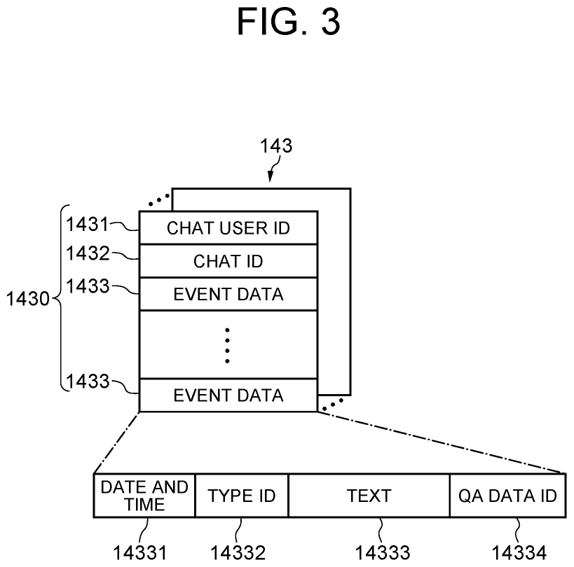

The chat log DB 143 is a database that stores the log information of a chat between the chatbot and a chat user. FIG. 3 shows an example of a configuration of the chat log DB 143. The chat log DB 143 in this example is composed of a plurality of entries each storing log information 1430 of one chat. The log information 1430 of a chat stored in each entry includes a chat user ID 1431, a chat ID 1432, and a plurality of event data 1433. An ID for uniquely identifying a chat user is set in the field of the chat user ID 1431. An ID such as a number for uniquely identifying each chat with the chat user identified by the chat user ID 1431 is set in the field of the chat ID 1432. Data on an event in the chat is set in the field of the event data 1433.

The event data 1433 includes a date and time 14331, a type 14332, a text 14333, and a QA data ID 14334. In the field of the type 14332, the type of the event data is set. There are a total of four types of event data: Session Established, Session Released, Question, and Response. Session Established means that a session for a chat is established (connected) between the chatbot and the chat user. Session Release means that the session established between the chatbot and the chat user is released (disconnected). Question means that the chatbot receives a question text from the chat user. Response means that the chatbot transmits a response text to the chat user. In the field of the date and time 14331, the date and time of occurrence of the event of the type is set, for example, in the format of “year, month, day, hour, minute, second, tenth of a second”. In the field of the text 14333, question text information is set when the type is Question, and response text information is set when the type is Response. When the type is Session Established or Session Released, NULL value is set in field of the text 14333, for example. When the type is Question, if QA data including a question text matching the text 14333 on the question is stored, the ID of the QA data is set and, if not stored, information that a matching question text is not registered is set in the field of the QA data ID 14333. When the type is Response, the same information as information set in the field of the QA data ID 14333 in the event data 1433 of a question that is the premise of the response is set in the field of the QA data ID 14333. When the type is Session Established or Session Released, NULL value is set in the field of the QA data ID 14333, for example.

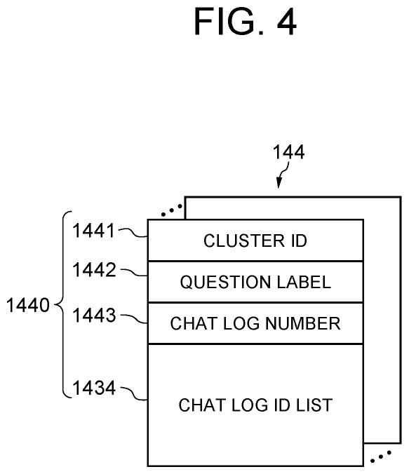

The cluster DB 144 is a database that stores information on one or more clusters generated by clustering a plurality of chat log information 1430 stored in the chat log DB 143 so that semantically similar log information are gathered into the same cluster. FIG. 4 shows an example of a configuration of the cluster DB 144. The cluster DB 144 in this example is composed of a plurality of entries each storing one cluster 1440. The cluster 1440 stored in each entry includes a cluster ID 1441, a question label 1442, a chat log number 1443, and a chat log ID list 1434. In the field of the cluster ID 1441, an ID such as a number for uniquely identifying the cluster 1440 is set. In the field of the question label 1442, a question text included commonly in the chat log information belonging to the cluster 1440 is set as a question label. In the field of the chat log ID list 1434, a list of the chat log IDs for identifying the chat log information 1430 belonging to the cluster ID 1440 is set. The chat log ID may be configured by a combination of the chat user ID 1431 and the chat ID 1432 shown in FIG. 3, for example.

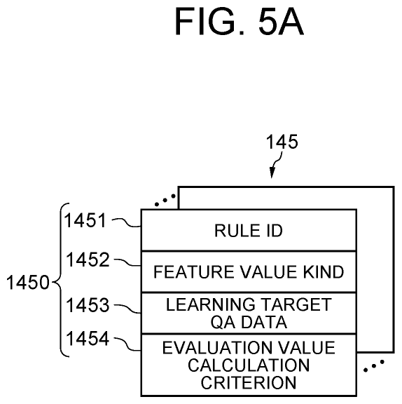

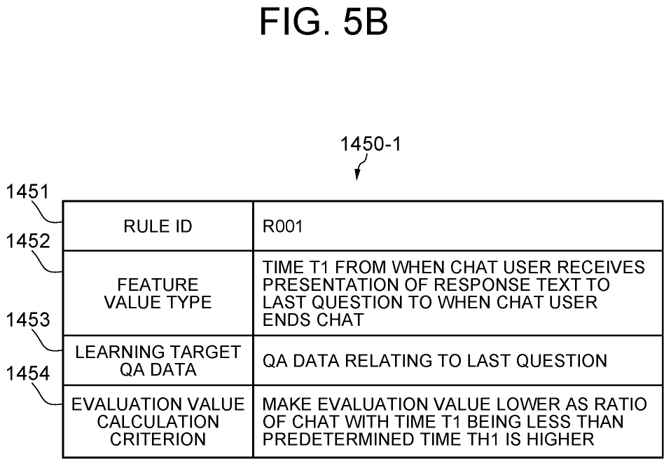

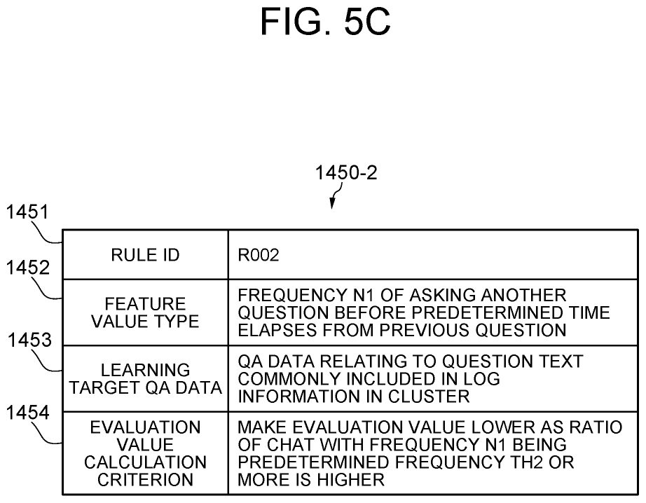

The rule DB 145 is a database that stores a rule for creating learning data representing whether QA data is good or bad from the log information in the cluster stored in the cluster DB 144. FIG. 5A shows an example of a configuration of the rule DB 145. The rule DB 145 in this example is composed of a plurality of entries each storing one rule 1450. The rule 1450 stored in each entry includes a rule ID 1451, a feature value type 1452, learning target QA data 1453, and an evaluation value calculation criterion 1454. In the field of the rule ID 1451, an ID such as a number for uniquely identifying the rule 1450 is set. In the field of the feature value type 1452, the type of a feature value of a temporal behavior during the chat of the chat user is set that is calculated from the log information in the cluster 1440 stored in the cluster DB 144. The temporal behavior includes an elapsed time from receiving a response to asking a question, an elapsed time from receiving a response to the end of the chat, the number of questions per unit time, an elapsed time from the start to the end of the chat, and the like. In the field of the learning target QA data 1453, data identifying QA data to be the target for creating learning data based on the feature value set in the field of the feature value type 1452 is set. In the field of the evaluation value calculation criterion 1454, a criterion for calculating an evaluation value indicating whether the QA data set in the field of the learning target QA data 1453 is good or bad is set.

FIG. 5B is a view showing an example of the rule stored in the rule DB 145. In a rule 1450-1 in this example, “time T1 from when a chat user receives presentation of a response text to the last question to when the chat user ends the chat” is set in the field of the feature value type 1452, “QA data relating to the last question” is set in the field of the learning target QA data 1453, and “make an evaluation value lower as the ratio of chat with the time T1 being less than a predetermined time TH1 is higher” is set in the field of the evaluation value calculation criterion 1454. This rule 1450-1 takes advantage of a chat user's tendency that when an exactly appropriate response (answer) is returned to a question, a chat user spends time somehow and makes efforts to understand the content of the response, but when an unwanted response or an irrelevant response is returned, a chat user may abandon solution by the chatbot at the moment of glancing at the response and close the chat screen immediately.

FIG. 5C is a view showing another example of the rule stored in the rule DB 145. In a rule 1450-2 in this example, “frequency N1 of asking another question before a predetermined time elapses from the previous question” is set in the field of the feature value type 1452, “QA data relating to the content of a question commonly included in the log information in the cluster” is set in the field of the learning target QA data 1453, and “male an evaluation value lower as the ratio of chat with the frequency N1 being predetermined frequency TH2 or more is higher” is set in the field of the evaluation value calculation criterion 1454. This rule 1450-2 takes advantage of a chat user's tendency that when an exactly appropriate response (answer) is not returned to a question, a chat user rephrases the content of a question and sometimes repeats the question many times.

The rules 1450 stored in the rule DB 145 are not limited to the rules 1450-1 and 1450-2 as describe above, and may be rules with other contents or may include three or more rules. For example, a rule in which the evaluation value calculation criterion 1454 of the rule 1450-1 is replaced with “make an evaluation value higher as the ratio of chat with the time T1 being the predetermined time TH1 or more is higher” may be used. Also, a rule in which the evaluation value calculation criterion 1454 of the rule 1450-2 is replaced with “make an evaluation value higher as the ratio of chat with the frequency N1 being less than the predetermined frequency TH2 is higher” may be used.

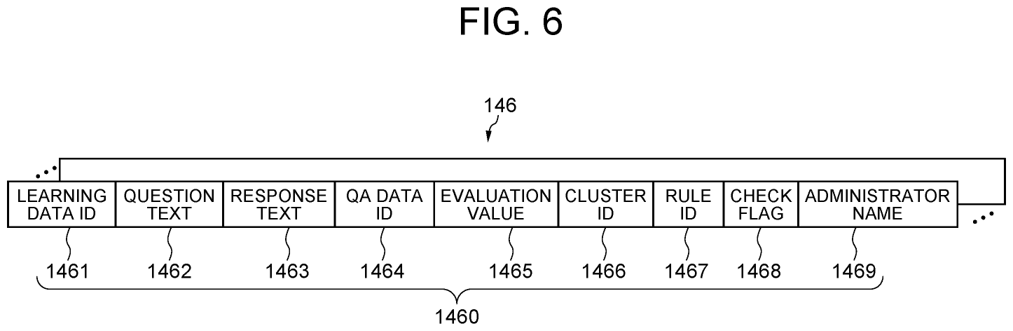

Referring to FIG. 1 again, the learning data DB 146 is a database that stores learning data showing whether QA data is good or bad. FIG. 6 shows an example of a configuration of the learning data DB 146. The learning data DB 146 in this example is composed of a plurality of entries each storing one learning data. Learning data 1460 stored in each entry includes a learning data ID 1461, a question text 1462, a response text 1463, a QA data ID 1464, an evaluation value 1465, a cluster ID 1466, a rule ID 1467, a check flag 1468, and an administrator name 1469. An ID such as a number for uniquely identifying learning data is set in the field of the learning data ID 1461. In the fields of the question text 1462 and the response text 1463, QA data to be evaluated, that is, a question text and a response text exchanged between the chat user and the chatbot are set. When QA data including a question text matching the question text set in the question text 1462 is stored, the ID of the stored QA data is set and, when not stored, information that a matching question text is not registered is set in the field of the QA data ID 1464. In the field of the evaluation value 1465, a value indicating whether the QA data to be evaluated is good or bad is set. The evaluation value 1465 may be, for example, binaries of a value representing that the QA data is good (e.g., 1) and a value representing that the QA data is bad (e.g., 0). Alternatively, the evaluation value 1465 may be multivalued so that the degree of whether the QA data is good or bad can be set in three or more stages (e.g., 10 stages). Alternatively, the evaluation value 1465 may further include a value indicating that the evaluation value has not been determined (e.g., NULL value). In the field of the cluster ID 1466, the cluster ID 1441 of the cluster 1440 used to generate the learning data is set. In the field of the rule ID 1467, the rule ID 1451 of the rule 1450 used to generate the learning data is set. In the field of the check flag 1468, a state indicating whether or not the learning data 1460 has been checked is set, for example, a value of 1 is set when checked and a value of 0 is set when not checked. In the field of the administrator name 1469, the name or the like of the chatbot administrator who has checked the learning data 1460 for maintenance of the QA data is set.

The operation processing unit 150 has one or a plurality of processors such as MPUs and a peripheral circuit thereof, and is configured to load the program 141 from the storing unit 140 and execute the program 141 to cause the abovementioned hardware and the program 141 cooperate and implement various processing units. Main processing units implemented by the operation processing unit 150 include a chatbot 151, a chat log collecting unit 152, a learning data generating unit 153, and a QA data managing unit 154. Here, a QA data evaluation apparatus is configured by the chat log collecting unit 152, the learning data generating unit 153, and the QA data managing unit 154.

The chatbot 151 is configured to have a chat with a chat user. The chatbot 151 establishes a chat session with a chat user in accordance with a request from the chat user. When a question text is transmitted from the chat user through the established session, the chatbot 151 receives the question text, searches the QA data DB 142 for QA data including a question text semantically matching the received question text, and acquires a response text included by the searched QA data. In a case where QA data including a question text semantically matching the received question text is not stored in the QA data DB 142, the chatbot 151 generates a previously determined template text, for example, a response text such as “Your question could not be recognized. Please rephrase and ask a question again.” Then, the chatbot 151 transmits the acquired or generated response text to the user terminal 160 of the chat user who made the inquiry, and displays the response text on the terminal screen of the user terminal 160. Moreover, the chatbot 151 releases the chat session established with the chat user in accordance with a request from the chat user.

The chat log collecting unit 152 is configured to collect log information of a chat with a chat user by the chatbot 151 and store the log information in the chat log DB 143. For example, when the chatbot 151 establishes a new chat session with a chat user, the chat log collecting unit 152 secures a new entry in the chat log DB 143, and sets the chat user ID 1431, the chat ID 1432, and the event data 1433 on Session Established (the date and time 14331 when the session is established, the type 14332 indicating Session Established, and the text 14333 and the QA data ID 14334 of NULL values) are set. Moreover, when the chatbot 151 receives a question text from the chat user through the abovementioned session, the chat log collecting unit 152 sets the event data 1433 on Question (the date and time 14331 when the question is received, the type 14332 indicating Question, the text 14333 representing question text information, and the QA data ID 14334) is set in the secured entry of the chat log DB 143. Moreover, when the chatbot 151 transmits a response text to the chat user through the abovementioned session, the chat log collecting unit 152 sets the event data 1433 on Response (the date and time 14331 when the response is transmitted, the type 14332 indicating Response, the text 14333 representing response text information, and the QA data ID 14334) is set in the secured entry of the chat log DB 143. Moreover, when the chatbot 151 releases the abovementioned session, the chat log collecting unit 152 sets event data 1433 on Session Released (the date and time 14331 when the session is released, the type 14332 indicating Session Released, and the text 14333 and the QA data ID 14334 of NULL values) in the secured entry of the chat log DB 143.

The learning data generating unit 153 is configured to create learning data representing whether QA data is good or bad using the chat log information stored in the chat log DB 143 and the rule stored in the rule DB 145 and store the learning data into the learning data DB 146. The learning data generating unit 153 starts a process to create learning data, for example, when a certain amount of log information is accumulated in the chat log DB 143, when a certain time passes from when learning data was created last time, at regular intervals, or when instructed by the operator. For example, the learning data generating unit 153 clusters a plurality of chat log information stored in the chat log DB 143 so that semantically similar log information are gathered into the same cluster, and stores the generated cluster into the cluster DB 144. Moreover, the learning data generating unit 153 applies the rule stored in the rule DB 145 to each cluster stored in the cluster DB 144, generates learning data by calculation of a feature value from the chat log information in the cluster, statistical processing of the calculated feature value, calculation of an evaluation value based on the result of the statistical processing, and so forth, and stores the generated learning data into the learning data DB 146. The statistical processing includes creation of frequency distribution, histogram, mean, median, mode, and the like.

The QA data managing unit 154 is configured to assist the administrator of the chatbot in performing a work to conduct maintenance such as modification, deletion and supplement of the QA data stored in the QA data DB 142 based on the learning data stored in the learning data DB 146. For example, the QA data managing unit 154 displays a list of the learning data stored in the learning data DB 146 on the screen display unit 130 so that the administrator can refer to the contents of the learning data. The QA data managing unit 154 also displays a list of the QA data stored in the QA data DB 142 on the screen display unit 130 so that the administrator can interactively correct, delete and supplement QA data.

Subsequently, the operation of the information processing apparatus 100 will be described in detail.

The operation of the information processing apparatus 100 is roughly divided into a chatbot process performed when an inquiry (question) from a chat user is accepted, and a QA data evaluation process. Moreover, the QA data evaluation process is roughly divided into a chat log collection process, a learning data generation process to generate learning data, and a maintenance process to conduct maintenance of QA data.

### <Chatbot Process and Chat Log Collection Process>

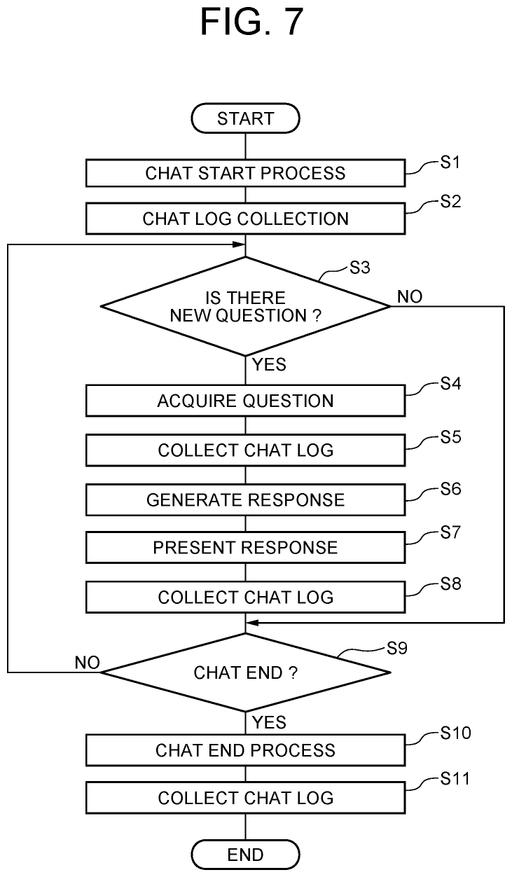

First, the chatbot process and the chat log collection process will be described with reference to a flowchart of FIG. 7. The chatbot process and the chat log collection process are performed for each user and each chat by the chatbot 151 and the chat log collecting unit 152.

When a chat user accepts an operation for starting a chat on the user terminal 160, the chatbot 151 of the information processing apparatus 100 performs a chat start process (step S1). In the chart start process at step S1, the chatbot 151 performs a process to establish a session for performing a chat between the user terminal 160 used by the chat user and the chatbot 151. In the chat stat process at step S1, the chatbot 151 may also display a template text in starting a chat (e.g., “Please enter your inquiry.”) on the screen of the user terminal 160 used by the chat user through the established session.

When the chat session is established between the chat user and the chatbot 151, the chat log collecting unit 152 performs the chat log collection process (step S2). In the chat log collection process at step S2, the chat log collecting unit 152 secures one new entry in the chat log DB 143 and sets, in the secured entry (referred to as the entry of interest hereinafter), the chat user ID 1431, the chat ID 1432, and the event data 1433 on Session Established (the date and time 14331 when the session is established, the type 14332 indicating Session Established, and the text 14333 and the QA data ID 14334 of NULL values).

Next, the chatbot 151 checks whether or not there is a new question from the chat user (step S3). A new question is entry of a new chat by the chat user. In a case where there is no entry of a new chat, the chatbot 151 proceeds to a process at step S9. In a case where there is entry of a new chat, the chatbot 151 acquires the content of the entered chat (question text) (step S4). When the chatbot 151 acquires a new question from the chat user, the chat log collecting unit 152 additionally sets the event data 1433 including the date and time 14331 when the question is received, the type 14332 indicating Question, the text 14333 representing question text information, and the QA data ID 14334 (NULL value at this moment) (step S5).

Next, the chatbot 151 searches the QA data DB 142 for QA data including a question text semantically matching the question text acquired from the chat user, and generates a response to the chat user using a response text included by the searched and obtained QA data (step S6). At step S6, in a case where QA data including a question text semantically matching the question text acquired from the chat user is not stored in the QA data DB 142, the chatbot 151 generates a response to the chat user using a previously set template text. In a case where QA data including a question text semantically matching the question text acquired from the chat user is stored in the QA data DB 142, the chat log collecting unit 152 sets the ID of the stored QA data in the QA data ID 14333 of the event data 1433 additionally set at step S5. In a case where not stored, the chat log collecting unit 152 sets the fact in the QA data ID 14333.

Next, the chatbot 151 transmits the generated response to the user terminal 160 used by the chat user, and displays the response on the screen of the user terminal 160 (step S7). When the chatbot 151 transmits the response to the user terminal 160 of the chat user, the chat log collecting unit 152 additionally sets, in the entry of interest of the chat log DB 143, the event data 1433 including the date and time 14331 when the response is transmitted, the type 14332 indicating Response, the text 14333 representing response text information, and the QA data ID 14334 (step S8). Then, the chatbot 151 proceeds to the process at step S9.

The chatbot 151 determines whether or not the end of the chat is detected at step S9. The chatbot 151 may determine that the end of the chat is detected, for example, when it is detected that the chat user has expressed his/her intention to end the chat on the user terminal 160. When determining that the end of the chat is not detected, the chatbot 151 returns to the process at step S3 and repeats the same processing as the processing described above. In a case where the end of the chat is detected, the chatbot 151 performs a chat end process (step S10). In the chat end process at step S10, the chatbot 151 performs a process to release (disconnect) the session established with the chat user. In the chat end process at step S10, the chatbot 151 may also display a template text in ending a chat (e.g., a text such as “Thank you for using”) on the screen of the user terminal 160 used by the chat user through the session before being released.

When the chatbot 151 releases the chat session, the chat log collecting unit 152 sets the event data 1433 on Session Released (the date and time 14331 when the session is released, the type 14332 indicating Session Released, and the text 14333 and the QA data ID 14334 of NULL values) in the entry of interest of the chat log DB 143 (step S11).

### <Learning Data Generation Process>

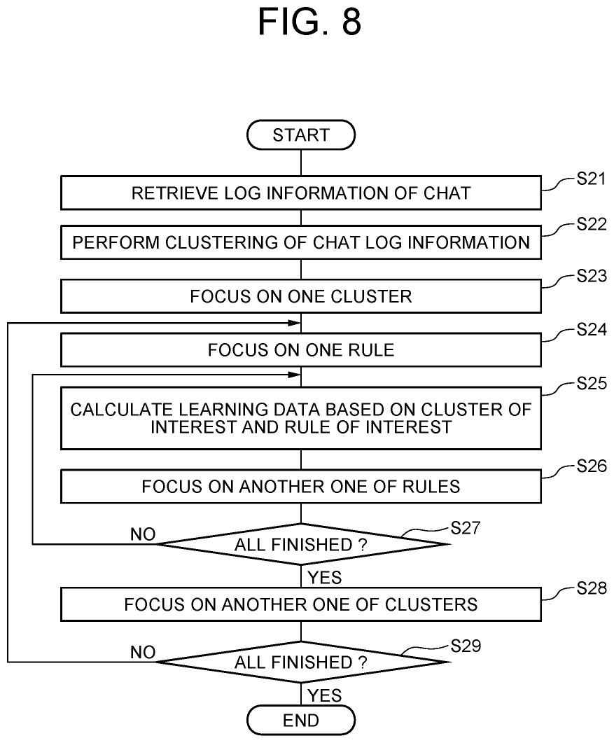

Next, the learning data generation process will be described with reference to a flowchart of FIG. 8. The learning data generation process is performed by the learning data generating unit 153.

When starting the learning data generation process, the learning data generating unit 153 of the information processing apparatus 100 first retrieves log information of a chat used for generation of learning data from the chat log DB 143 (step S21). For example, the learning data generating unit 153 may retrieve all the log information stored in the chat log DB 143 as log information to be used for generation of learning data. Alternatively, the learning data generating unit 153 may refer to the date and time set in the date and time 14331 and retrieve, for example, all the log information after a predetermined date and time specified by the administrator or the like, or all the log information before the predetermined date and time, or all the log information after a predetermined start date and time and before a predetermined end date and time, as log information to be used for generation of learning data from the chat log DB 143.

Next, the learning data generating unit 153 clusters the retrieved log information so that semantically similar log information are gathered into the same cluster (step S22). Being semantically similar means that the contents of exchanged question text and response text are similar overall and semantically between the mutual chat log information. For example, “I want to cancel my application for a leave of absence” and “I want to withdraw my leave of absence” are an example of chat log information that are semantically similar to each other. Also, “price is high” and “expensive”, and “great-looking” and “great in appearance” are other examples of chat log information that are semantically similar to each other. Any clustering method may be used to gather semantically similar chat log information into the same cluster. For example, the abovementioned clustering may be performed by collecting a question text and a response text in each chat log information as a single document and applying a known document clustering method of classifying similar documents into the same cluster on the documents.

The known document clustering method is, but not limited to, a document clustering method described in Patent Literature 4, for example. In the document clustering method described in Patent Literature 4 (referred to as the document clustering method related to the present invention hereinafter), first, on any combination of two words composed of a word appearing in one document of two documents included by documents and a word appearing in the other document among words appearing in the two documents, a concept tree structure showing the hierarchical relation between the concepts of the two words is acquired. Next, for the combination described above, a concept similarity degree serving as an indicator of the closeness of the concepts of the two words is obtained that is maximum when appearance frequency in the documents of a common hypernym of the two words in the acquired concept tree structure or a hyponym of the hypernym matches appearance frequency of each of the two words in the documents and that is minimum when there is no common hypernym of the two words in the concept tree structure. Next, based on the concept similarity degree, a documents similarity degree that is the degree of semantic similarity between the two documents included by the documents is obtained. Next, based on the documents similarity degree, document clustering is performed on the documents.

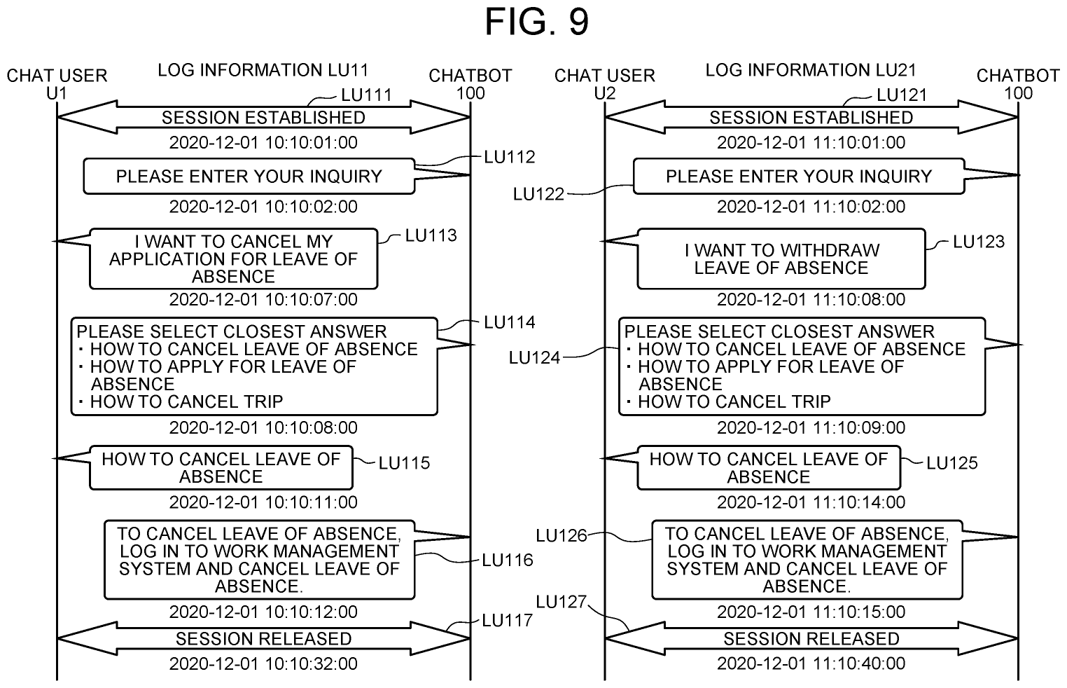

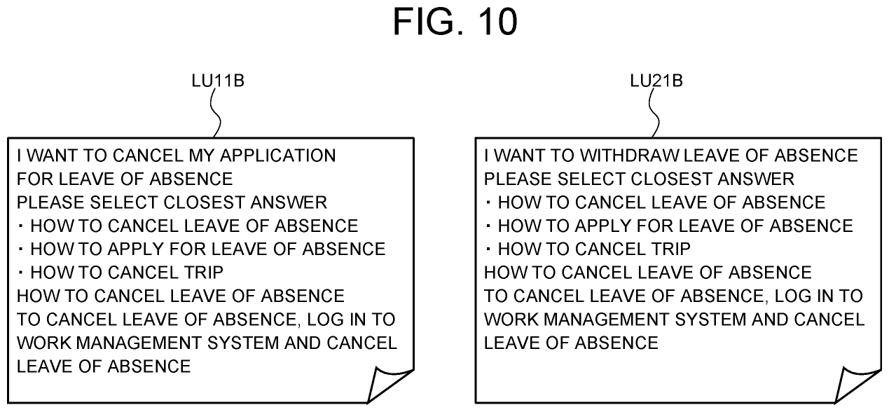

For example, it is assumed that the learning data generating unit 153 clusters log information including log information LU11 and LU21 of two chats shown in FIG. 9 using the document clustering method related to the present invention. In FIG. 9, the chat log information LU11 on the left side shows log information of a chat between a chat user U01 and the chatbot 151, and the log information LU21 on the right side shows log information of a chat between a chat user U02 and the chatbot 151. Moreover, in FIG. 9, a bidirectional arrow indicates an event of chat session establishment or release, and a speech bubble indicates an event of a response comment transmitted from the chatbot 151 to the chat user, or a question comment received by the chatbot 151 from the chat user. Moreover, date and time written under each event indicates the date and time of the occurrence of the event. In order to identify each of the events, the respective events are denoted by reference numerals LU111 to LU117 and LU211 to LU217 for convenience. In the case of such chat log information, the learning data generating unit 153 collects question text and response text in the log information LU11 shown in FIG. 9 to generate one document LU11B as shown in FIG. 10. In the example of FIG. 10, template texts common to all the chats, such as “Please enter your inquiry” and “Thank you for using”, which are presented by the chatbot 151 to the chat users at the start and end of the chat, are excluded. The learning data generating unit 153 also collects question text and response text in the log information LU21 to generate one document LU21B as shown in FIG. 10. Then, the learning data generating unit 153 clusters documents including the documents LU11B and LU21B by applying the document clustering method related to the present invention. As a result, in the case of the two log information LU11 and LU21 shown in FIG. 9, although question text “I want to cancel my application for a leave of absence” of the event LU113 and question text “I want to withdraw my leave of absence” of the event LU213, which are semantically identical but are different at the word level, are in separate log information, the two log information LU11 and LU21 are classified into the same cluster.

At step S22, the learning data generating unit 153 generates the cluster 1440 composed of the cluster ID 1441, the question label 1442, the chat log number 1443 and the chat log ID list 1434 for each of the clusters generated by the clustering, and stores the cluster 1440 into the cluster DB 144. For example, the learning data generating unit 153 sets a question text “how to cancel a leave of absence” that appears commonly in a plurality of chat log information in the question label 1442 of a cluster to which the two log information shown in FIG. 9 belong.

Next, the learning data generating unit 153 focuses on one cluster 1440 among the one or more clusters stored in the cluster DB 144 (step S23). Next, the learning data generating unit 153 focuses on one rule 1450 among the one or more rules stored in the rule DB 145 (step S24). Next, the learning data generating unit 153 creates the learning data 1460 based on the cluster 1440 of interest and the featured rule 1450 of interest, and stores the learning data 1460 into the learning data DB 146 (step S25).

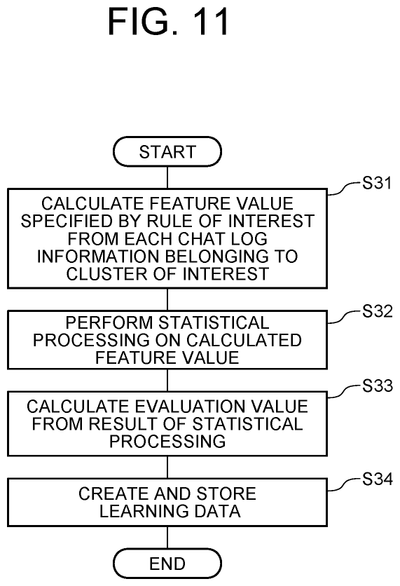

FIG. 11 is a flowchart showing an example of the process executed at step S25 by the learning data generating unit 153. Referring to FIG. 11, the learning data generating unit 153 first calculates a feature value of a type set in the field of the feature value type 1452 of the rule 1450 of interest from each of the chat log information 1430 in the cluster 1440 of interest (step S31). For example, in the case of the rule 1450-1, the learning data generating unit 153 calculates “time T1 from when a chat user receives presentation of a response text to the last question to when the chat user ends the chat” from each chat log information. For example, in the case of the log information LU11 shown in FIG. 9, the event LU116 is the response to the chat user's last question, so that time from the date and time of the event LU116 to the end of the chat of the event LU117 is calculated as time T1. Moreover, for example, in the case of the rule 1450-2, the learning data generating unit 153 calculates “frequency N1 of asking another question before a predetermined time elapses from the previous question” from each log information. For example, in the case of the log information LU11 shown in FIG. 9, questions are asked two times of the events LU113 and LU115, so that the frequency N1 is 1 when the elapsed time from the event LU113 to the event LU115 is less than the predetermined time and the frequency N1 is 0 when it is the predetermined time or more. Incidentally, in the case of chat log information with the total number of questions being M, the maximum value of the frequency N1 is M−1.

Next, the learning data generating unit 153 performs statistical processing on the feature values calculated from the respective chat log information based on the evaluation value calculation criterion 1454 of the rule 1450 of interest (step S32). For example, in the case of the rule 1450-1, the learning data generating unit 153 first calculates a total number S1 of chat log information with the time T1 being less than a predetermined time TH1. Next, the learning data generating unit 153 calculates a ratio R1 of the total number S1 to a total number S0 of chat logs in the cluster of interest. In the case of the rule 1450-2, the learning data generating unit 153 first calculates the total number S1 of chat log information with the frequency N1 being equal to or more than predetermined frequency TH2. Next, the learning data generating unit 153 calculates the ratio R1 of the total number S1 to the total number S0 of chat logs in the cluster of interest. Next, the learning data generating unit 153 calculates an evaluation value from the result of the statistical processing (step S33). For example, in the cases of the rule 1450-1 and the rule 1450-2, the learning data generating unit 153 makes the evaluation value lower as the ratio R1 is higher. For example, the learning data generating unit 153 calculates the evaluation value as 0 when the ratio R1 is equal to or more than 80%, calculates the evaluation value as 2 when the ratio R1 is equal to more than 60% and less than 80%, calculates the evaluation value as 5 when the ratio R1 is equal to or more than 40% and less than 60%, calculates the evaluation value as 8 when the ratio R1 is equal to or more than 20% and less than 40%, and calculates the evaluation value as 10 when the ratio R1 is less than 20%. Here, the larger the evaluation value, the higher the evaluation.

Next, the learning data generating unit 153 creates the learning data 1460 in which necessary information is set in each of the fields of the learning data ID 1461, the question text 1466, the response text 1463, the QA data ID 1464, the evaluation value 1464, the cluster ID 1466 and the rule ID 1467, a value indicating an unchecked state is set in the check flag 1468 and a NULL value is set in the administrator name 1469, and stores the learning data 1460 into the learning data DB 146. The learning data generating unit 153 sets the cluster ID 1441 of the cluster 1440 of interest and the rule ID 1451 of the rule 1450 of interest in the fields of the cluster ID 1466 and the rule ID 1467. Moreover, the learning data generating unit 153 sets the evaluation value calculated at step S33 in the field of the evaluation value 1465. Moreover, the learning data generating unit 153 sets a question text, a response text and the QA data ID 1421 of QA data including them specified by the learning target QA data 1453 of the rule 1450 identified by the rule ID 1467 in the fields of the question text 1462, the response text 1463 and the QA data ID 1464.

Referring to FIG. 8 again, when finishing the process of step S25, the learning data generating unit 153 focuses on one of the rules having not yet been applied to the cluster of interest among the rules stored in the rue DB 145 (step S28), returns to step S25 via step S27, and repeats the same processing as the abovementioned processing using the other rule on the cluster of interest. Moreover, when finishing applying all the rules to the cluster of interest (YES at step S27), the learning data generating unit 153 focuses on one of the clusters having not yet been processed among the clusters stored in the cluster DB 144 (step S28), returns to step S24 via step S29, and repeats the same processing as the abovementioned processing on the other cluster. Moreover, when finishing focusing on all the clusters (YES at step S29), the learning data generating unit 153 ends the processing in FIG. 8.

### <QA Data Maintenance Process>

Next, the data maintenance process will be described. The data maintenance process is performed by the QA data managing unit 154.

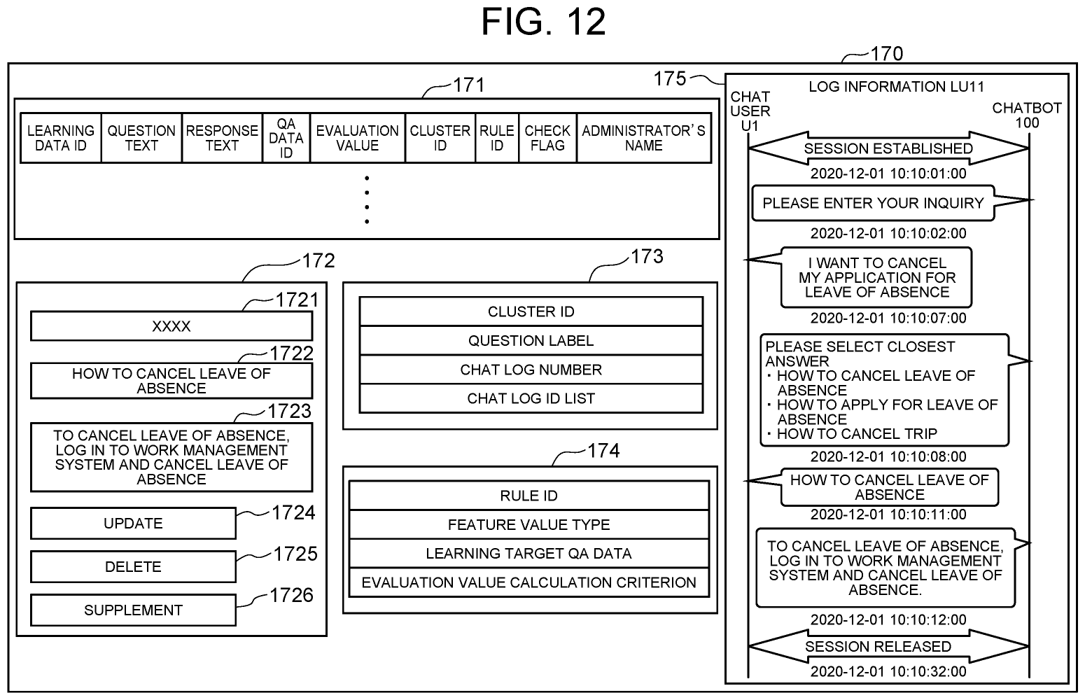

FIG. 12 shows an example of a chatbot management screen 170 displayed on the screen display unit 130 when the QA data managing unit 154 is activated by the administrator of the information processing apparatus 100. The chatbot management screen 170 in this example has a learning data list display region 171, a QA data edition region 172, a cluster display region 173, a rule display region 174, and a chat log display region 175.

The learning data list display region 171 is a region to display a list of one or more learning data 1460 stored in the learning data DB 146. The QA data managing unit 154 may retrieve all the learning data 1460 stored in the learning data DB 146 and display in the learning data list display region 171. Alternatively, the QA data managing unit 154 may selectively retrieve some learning data 1460 from all the learning data stored in the learning data DB 146, and display in the learning data list display region 171. Some learning data may be learning data in which the check flag 1468 indicates the unchecked state. Alternatively, some learning data may be those that the evaluation value 1465 is higher or lower than an evaluation value specified by the administrator. The QA data managing unit 154 considers one of the learning data displayed in the learning data list display region 171 as current learning data. The QA data managing unit 154 clearly shows the current learning data to the administrator, for example, by highlighting it. Moreover, the QA data managing unit 154 sets Checked in the field of the check flag 1468 of the current learning data, and sets the name or the like of an administrator logging in to the management screen in the field of the administrator name 1469. When instructed to change by the administrator's cursor operation, the QA data managing unit 154 switches the current learning data to another learning data instructed.

The QA data edition region 172 is a region for perform edition such as update, deletion and supplement of QA data. The QA data edition region 172 has a QA data ID field 1721, a question text field 1722, a response text field 1723, an update button 1724, a delete button 1725, and a supplement button 1726. The QA data managing unit 154 displays the QA data ID 1464, the question text 1462 and the response text 1463 of the current learning data in the QA data ID field 1721, the question text field 1722 and the response text field 1723. The QA data managing unit 154 also edits the contents of the question text field 1722 and the response text field 1723 in accordance with an edition operation of the operation input unit 120 by the administrator. Moreover, when the update button 1724 is pressed by the administrator, the QA data managing unit 154 updates (overwrites) QA data of the QA data DB 142 identified by the QA data ID set in the QA data ID field 1721 with the contents of the question text and response text set in the question text field 1722 and response text field 1723 after edition. Moreover, when the delete button 1725 is pressed by the administrator, the QA data managing unit 154 deletes the QA data in the QA data DB 142 identified by the QA data ID set in the QA data ID field 1721. Moreover, when the supplement button 1726 is pressed by the administrator, the QA data managing unit 154 creates QA data that has a new QA data ID and has the contents of the question text and the response text set in the question text field 1722 and the response text field 1726 after edition, and supplements the QA data DB 142 with new QA data.

The cluster display region 173 displays the content of the cluster 1440, that is, the cluster ID 1441, the question label 1442, the chat log number 1443, and the chat log ID list 1434. The QA data managing unit 154 retrieves the content of the cluster 1440 having the cluster ID 1441 matching the cluster ID 1466 of the current learning data from the cluster DB 144, and displays in the cluster display region 173. The QA data managing unit 154 sets one chat log ID in the chat log ID list 1434 displayed in the cluster display region 173 as a current chat log ID. The QA data managing unit 154 clearly shows the current chat log ID to the administrator, for example, by highlighting it. The QA data managing unit 154 switches the current chat log ID to a specified chat log ID in the chat log ID list 1434 in response to a change instruction by the administrator's cursor operation.

The chat log display region 175 is a region to display chat log information. The QA data managing unit 154 retrieves chat log information having a chat log ID matching the current chat log ID from the chat log DB 143, and displays in the chat log display region.

The rule display region 174 is a region to display the content of the rule 1450, that is, the rule ID 1451, the feature value type 1452, the learning target QA data 1453 and the evaluation value calculation criterion 1454. The QA data managing unit 154 retrieves the rule 1450 having the rule ID 1451 matching the rule ID 1467 of the current learning data from the rule DB 145, and displays in the rule display region 174.

Since the QA data managing unit 154 performs the processing as described above using the chatbot management screen 170 shown in FIG. 12, the administrator of the information processing apparatus 100 can interactively modify, delete, and supplement QA data to be learned target while individually referring to the learning data 1460 stored in the learning data DB 146. Moreover, since the QA data managing unit 154 displays the content of the cluster 1440 used for creation of the learning data 1460 in the cluster display region 173 and displays the details of the chat log information composing the cluster 1440 in the chat log display region 175, the administrator can modify, delete, and supplement the QA data while checking what kind of cluster 1440 and set of chat log information the learning data 1460 is generated from. Moreover, since the QA data managing unit 154 displays the content of the rule 1450 used for creation of the learning data 1460 in the rule display region 174, the administrator can modify, delete, and supplement the QA data while checking what kind of rule 1450 the learning data 1460 is generated from.

As described above, the information processing apparats 100 according to this example embodiment makes it possible to easily acquire inactive evaluation information. The reason is that the information processing apparatus 100 makes it possible to perform all of collection of chat log information, calculation of feature values from the collected chat log information, and calculation of an evaluation value based on the calculated feature values on the information processing apparatus 100 side and therefore there is no need to necessarily provide the chat user side with special equipment such as a microphone, a camera, and a biodetection sensor.

Further, the information processing apparats 100 according to this example embodiment clusters a plurality of log information so that semantically similar log information are gathered into the same cluster, extracts a predetermined feature value from each of the plurality of log information belonging to the same cluster and, based on the result of statistical processing on the extracted feature values, creates learning data representing whether QA data relating to a question text commonly included in log information in the cluster is good or bad. Therefore, it is possible to reduce variations in evaluation due to the behavior of a specific chat user.

Further, since the information processing apparatus 100 according to this example embodiment uses, as the feature value, “time from when a response to the last question is presented to the end of the chat” (rule 1450-1) or “frequency of asking another question before a predetermined time elapses from the previous question” (rule 1450-2), it is possible to create learning data on which the opinion of the silent majority is reflected.

### Second Example Embodiment

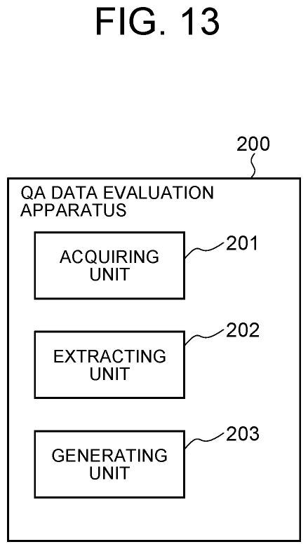

Next, a QA data evaluation apparatus according to a second example embodiment of the present invention will be described with reference to the drawings. FIG. 13 is a block diagram of a QA data evaluation apparatus 200 according to this example embodiment.

Referring to FIG. 13, the QA data evaluation apparatus 200 includes an acquiring unit 201, an extracting unit 202, and a generating unit 203.

The acquiring unit 201 is configured to acquire QA data including the content of a question from a user to a chatbot and the content of a response to the question by the chatbot, and log information on the use of the chatbot by the user.

The extracting unit 202 is configured to extract a feature value relating to a temporal behavior of the use of the chatbot by the user from the log information.

The generating unit 203 is configured to generate QA data evaluation information representing whether the QA data is good or bad based on the feature value.

The QA data evaluation apparatus 200 thus configured operates in the following manner. First, the acquiring unit 201 acquires QA data including the content of a question from a user to a chatbot and the content of a response to the question by the chatbot, and log information on the use of the chatbot by the user. Next, the extracting unit 202 extracts a feature value relating to a temporal behavior of the use of the chatbot by the user from the log information. Next, the generating unit 203 generates QA data evaluation information representing whether the QA data is good or bad based on the feature value.

With the QA data evaluation apparatus 200 configured and operating as described above, it is possible to easily acquire inactive evaluation information. The reason is that the QA data evaluation apparatus 200 makes it possible to perform all of collection of chat log information, calculation of a feature value from the collected chat log information, calculation of an evaluation value based on the calculated feature value, and so forth, on the QA data evaluation apparatus 200 side and there is no need to necessarily provide the chat user side with special equipment such as a microphone, a camera and a biodetection sensor.

Although the present invention has been described above with reference to the example embodiments, the present invention is not limited to the above example embodiments. The configurations and details of the present invention can be changed in various manners that can be understood by one skilled in the art within the scope of the present invention. For example, a modification example as shown below may be included by the present invention.

In the example embodiments described above, the feature value of a temporal behavior during a chat of a chat user is calculated from chat log information, and learning data representing whether QA data is good or bad is created based on the calculated feature value. However, in addition to the feature value of the temporal behavior during the chat of the chat user calculated from the chat log information, other information may be considered to create the learning data. Examples of other information include active evaluation information, chat user's voice, image, biometric information (pulse, heart rate, blood pressure, brain waves, respiration rate, etc.), URL selection, date and time of use, and user terminal information (PC, smartphone, etc.).

Active evaluation information is created based on information of a reaction shown by a chat user who received a response during the operation of a chatbot. Active evaluation information is information that a chat user actively and deliberately enters for the purpose of evaluating a presented response. Examples of active evaluation information include utterance, text, pictogram, stamp and the like expressing “like”, “great”, “clever” and the like indicating good evaluation and “dislike”, “no good” and the like indicating bad evaluation. Active evaluation information is input by means of social buttons indicating “good” or “bad”, for example. However, since it is not always possible to obtain active evaluation information, active evaluation information necessary for generating learning data may be insufficient. It is said that active evaluation information is obtained for about 10% of all questions. Therefore, it is important to measure the chat user's degree of satisfaction and evaluation to a presented response using information other than active evaluation information, that is, using inactive evaluation information, and create learning data. According to the present invention, such inactive evaluation information can be easily created.

### INDUSTRIAL APPLICABILITY

The present invention can be applied to operation management of a chatbot and, for example, can be applied to maintenance of QA data.

The whole or part of the example embodiments disclosed above can be described as, but not limited to, the following supplementary notes.

### [Supplementary Note 1]

A QA data evaluation apparatus comprising:
an acquiring unit that acquires QA data including a content of a question from a user to a chatbot and a content of a response to the question by the chatbot, and log information on use of the chatbot by the user;
an extracting unit that extracts a feature value relating to a temporal behavior of the use of the chatbot by the user from the log information; and
a generating unit that generates QA data evaluation information representing whether the QA data is good or bad based on the feature value.

### [Supplementary Note 2]

The QA data evaluation apparatus according to Supplementary Note 1, further comprising
a clustering unit that classifies a plurality of the log information into a plurality of clusters in accordance with semantic similarity of the log information, wherein:
the extracting unit extracts the feature value from each of a plurality of the log information belonging to each of the plurality of clusters; and
the generating unit generates the QA data evaluation information based on a result of statistical processing on a plurality of the feature values extracted, respectively, from the plurality of log information.

### [Supplementary Note 3]

The QA data evaluation apparatus according to Supplementary Note 1 or 2, wherein
the feature value is a feature value relating to a time from outputting a content of a response to a last question from the user to ending a chat.

### [Supplementary Note 4]

The QA data evaluation apparatus according to Supplementary Note 1 or 2, wherein
the feature value is a feature value relating to a frequency that a content of another question is input before a predetermined time elapses after a moment when a content of a question from the user to the chatbot is input.

### [Supplementary Note 5]

The QA data evaluation apparatus according to any of Supplementary Notes 1 to 4, further comprising
a QA data managing unit that displays the generated QA data evaluation information.

### [Supplementary Note 6]

The QA data evaluation apparatus according to Supplementary Note 5, wherein
the QA data managing unit updates, deletes, or supplements the QA data in accordance with an operation input to the QA data by an administrator of the chatbot.

### [Supplementary Note 7]

The QA data evaluation apparatus according to Supplementary Note 5 or 6, wherein
the QA data managing unit displays the log information used for generation of the QA data evaluation information.

### [Supplementary Note 8]

The QA data evaluation apparatus according to any of Supplementary Notes 5 to 7, wherein
the QA data managing unit displays a rule that includes a type of the feature value used for generation of the QA data evaluation information from the log information and a criterion for calculation of an evaluation value representing whether the QA data is good or bad.

### [Supplementary Note 9]

A QA data evaluation method comprising:
acquiring QA data including a content of a question from a user to a chatbot and a content of a response to the question by the chatbot, and log information on use of the chatbot by the user;
extracting a feature value relating to a temporal behavior of the use of the chatbot by the user from the log information; and
generating QA data evaluation information representing whether the QA data is good or bad based on the feature value.

### [Supplementary Note 10]

A non-transitory computer-readable recording medium having a program recorded thereon, the program comprising instructions for causing a computer to execute:
a process to acquire QA data including a content of a question from a user to a chatbot and a content of a response to the question by the chatbot, and log information on use of the chatbot by the user;
a process to extract a feature value relating to a temporal behavior of the use of the chatbot by the user from the log information; and
a process to generate QA data evaluation information representing whether the QA data is good or bad based on the feature value.

### REFERENCE SIGNS LIST

100 information processing apparatus
110 communication IN unit
120 operation input unit
130 screen display unit
140 storing unit
141 program
142 QA data DB
143 chat log DB
144 cluster DB
145 rule DB
146 learning data DB
150 operation processing unit
151 chatbot
152 chat log collecting unit
153 learning data generating unit
154 QA data managing unit

What is claimed is:

1. A data evaluation apparatus comprising:
a memory containing program instructions; and
a processor coupled to the memory, wherein the processor is configured to execute the program instructions to:
acquire data including a content of a question from a user to a chatbot and a content of a response to the question by the chatbot, and log information on use of the chatbot by the user;
extract a feature value relating to a temporal behavior of the use of the chatbot by the user from the log information; and
generate data evaluation information representing whether the data is good or bad based on the feature value.

2. The data evaluation apparatus according to claim 1, wherein the processor is further configured to execute the instructions to:
classify a plurality of the log information into a plurality of clusters in accordance with semantic similarity of the log information;
in the extracting, extract the feature value from each of a plurality of the log information belonging to each of the plurality of clusters; and
in the generating, generate the data evaluation information based on a result of statistical processing on a plurality of the feature values extracted, respectively, from the plurality of log information.

3. The data evaluation apparatus according to claim 1, wherein
the feature value is a feature value relating to a time from outputting a content of a response to a last question from the user to ending a chat.

4. The data evaluation apparatus according to claim 1, wherein
the feature value is a feature value relating to a frequency that a content of another question is input before a predetermined time elapses after a moment when a content of a question from the user to the chatbot is input.

5. The data evaluation apparatus according to claim 1, wherein the processor is further configured to execute the instructions to
output the generated data evaluation information.

6. The data evaluation apparatus according to claim 5, wherein the processor is further configured to execute the instructions to
update, delete, or supplement the data in accordance with an operation input to the data by an administrator of the chatbot.

7. The data evaluation apparatus according to claim 5, wherein the processor is further configured to execute the instructions to
output the log information used for generation of the data evaluation information.

8. The data evaluation apparatus according to claim 5, wherein the processor is further configured to execute the instructions to
output a rule that includes a type of the feature value used for generation of the data evaluation information from the log information and a criterion for calculation of an evaluation value representing whether the data is good or bad.

9. A data evaluation method comprising:
by a processor, acquiring data including a content of a question from a user to a chatbot and a content of a response to the question by the chatbot, and log information on use of the chatbot by the user;
by the processor, extracting a feature value relating to a temporal behavior of the use of the chatbot by the user from the log information; and
by the processor, generating data evaluation information representing whether the data is good or bad based on the feature value.

10. A non-transitory computer-readable recording medium having a program recorded thereon, the program comprising instructions for causing a computer to execute:
a process to acquire data including a content of a question from a user to a chatbot and a content of a response to the question by the chatbot, and log information on use of the chatbot by the user;
a process to extract a feature value relating to a temporal behavior of the use of the chatbot by the user from the log information; and
a process to generate data evaluation information representing whether the data is good or bad based on the feature value.
